(19) United States
(12) Patent Application Publication
(10) Pub. No.: US 2014/0214468 A1
(43) Pub. Date: Jul. 31, 2014

(54) METHOD OF MANAGING A CONFIDENTIAL MODERATED CROWDSOURCE PROBLEM SOLVING SYSTEM

(71) Applicants: Scott Hunter Wurtele, Sidney (CA); Paul Edward Wagorn, Victoria (CA); Daniel Jonathan Knopp, Whistler (CA); Lavern Alfred Burkhardt, Saanichton (CA)

(72) Inventors: Scott Hunter Wurtele, Sidney (CA); Paul Edward Wagorn, Victoria (CA); Daniel Jonathan Knopp, Whistler (CA); Lavern Alfred Burkhardt, Saanichton (CA)

(73) Assignee: IdeaConnection Ltd, Victoria (CA)

(21) Appl. No.: 13/763,714

(22) Filed: Feb. 10, 2013

Related U.S. Application Data
(60) Provisional application No. 61/756,596, filed on Jan. 25, 2013.

(51) Int. Cl. G06Q 10/10

(52) U.S. Cl. CPC G06Q 10/103
USPC 705/7.14

(57) ABSTRACT

Internet web server based method/system for providing confidential, moderated, crowdsourced problem solving resources to solve various problems. A crowdsource database of various skilled individuals interested in acting as problem solvers and team facilitators is provided, along with a database of client proposed problems, divided into non-confidential and confidential problem statement sections, key skills needed, and other criteria. These criteria are used as an index to the crowdsource database, and potential matches found. An administrator uses a server provided dashboard GUI, and the non-confidential problem statements, to pick among the various proposed matches, determine interest, and form small facilitator moderated teams. After suitable NDA, the confidential problem statement is revealed, and the teams interact confidentially with the client through the server. Facilitator moderation, problem restatement, and other methods reduce burden on the client and improve solution quality. Client accepted solutions, optionally after team release of IP, result in team member payment.

### CROSS REFERENCE TO RELATED APPLICATIONS

This invention claims the priority benefit of provisional patent application 61/756,596, inventors Scott Wurtele and Paul Wagorn, filed Jan. 25, 2013, entitled “A low risk method for solving complex R&D problems and obtaining highly innovative solutions”; the contents of which are incorporated herein by reference.

### BACKGROUND OF THE INVENTION

1. Field of the Invention

This invention is in the field of Internet based computer network systems for managing complex crowdsourced projects; particularly Internet based systems that operate using web servers that are also capable of managing multiple projects from multiple clients.

2. Description of the Related Art

Computer network based systems have been used for various project management purposes almost from the beginning of the computer era. However these early computerized project management systems, which predated the advent of the Internet, were generally focused on managing projects within a company or government organization, or within an organization and a defined group of company suppliers or customers.

As the cost of computers decreased, and the popularity of the Internet increased, various Internet based computer systems to allow clients with particular problems to solicit solutions from various independent contractors became popular. Examples of two such popular contractor systems in widespread use today include Tsatalos, US patent publication 20060284838, assigned to oDesk® Corporation; and Sheth, US patent publication 2001/0032170, and U.S. Pat. No. 7,069,242 both assigned to Elance® Corporation.

More recently, a method of distributed problem solving called “crowdsourcing” has become popular. Crowdsourcing generally operates by using an Internet based computer system to solicit ideas and services from large groups of generally undefined individuals (i.e. the general public). In recent years, various organizations, such as Innocentive, Inc., have utilized various crowdsourced computer implemented methods to solve problems of interest to various corporations. Some of the technology behind the Innocentive approach is exemplified by Bingham et. al in US patent publication 20040054582, Carroll in US patent publications 20070244840, and 20070239464 and Spradlin et al in US patent publication 20090299760.

Despite these advances, there are a number of aspects of such prior art systems that are less than ideal for many situations. Thus further advances in this art would be commercially important.

### BRIEF SUMMARY OF THE INVENTION

The invention is based, in part, on the insight that throughout the world, there are many highly experienced and talented professional scientists, engineers, and other practitioners of other professions that are either underemployed or working in areas, such as teaching, where they may have extra time, energy, and even resources. At least some of these individuals may wish to challenge their intellects or supplement their income by taking on additional problems in their area of expertise, and have no legal impediments to their doing so.

The invention is also based, in part, on the insight that many business organizations, and even some governmental or non-profit organizations, may have too many problems (e.g. research or engineering problems) to conveniently handle using existing organizational resources. Such organizations might welcome occasional outside help for such overflow problems, but only if such outside help was cost effective, had a good chance of providing good solutions without wasting a lot of the organizational employee time, and most importantly would preserve organizational confidentiality and access to intellectual property in the event that good solutions were provided.

The invention is also based, in part, on the insight that although prior art computerized crowdsourcing methods are effective at bringing large numbers of individuals together to try to solve various problems, such crowdsource methods tended to form large “mobs” of individuals with dubious qualifications that would tend to overwhelm organizational employees with too many repetitious questions, and would also tend to generate too many spurious “solutions” of doubtful utility. An additional problem with prior art crowdsourcing methods is that any organization using such prior art methods would have a high risk of compromising its confidential information, losing the rights to any intellectual property generated by the process, and risk that the solutions might be legally “tainted” because employees from competitors might have been part of that particular crowd.

In one embodiment, the invention may be an Internet web server based method/system for providing confidential, moderated, crowdsourced problem solving resources to solve various problems. The invention operates using a crowdsource database comprised of various skilled individuals who are interested in acting as either problem solvers and/or team facilitators. The invention also operates using a database of client proposed problems. These client proposed problems are generally divided into non-confidential problem statements, confidential problem statements, key problem solvers skills needed, list of problem solver inclusions or exclusions, and other criteria.

The client criteria are used by the automated system as an index to search the crowdsource database, and potential matches where candidate problem solvers and facilitators match the client problem solver criteria are found. An administrator, who acts as a second level of management in the process, may use a server provided dashboard GUI, as well as the non-confidential problem statements, to pick among the various potential problem solver matches, and conduct preliminary discussion with these candidate problem solvers using the non-confidential part of the client problem statement. Those candidate problem solvers who are willing and who have generally appropriate credentials, and after submission of suitable non-disclosure agreements (NDA), can then be either selected and/or approved by the administrator and formed into small online facilitator lead and moderated teams.

Generally after the NDA and team formation step, the system will reveal the confidential portion of the client problem statement to the teams. Through some or all of the subsequent problem solving process, teams can interact confidentially with the client through the system server. The identity of the team members can remain obscured from the client, and the identity of the client can remain obscured from the team members.

Various further methods, such as facilitator moderation and problem restatement can reduce the burden on the client during the problem solving process, as well as improve solution quality. Once the client accepts the solution, funds can be released to the team members, optionally contingent on if the client first requires that team members formalize the process of assigning any problem solution related IP rights to the client.

### BRIEF DESCRIPTION OF THE DRAWINGS

FIG. 1 shows an overview of how the invention's Internet server based system and methods can assemble information from variety of potential problem solver candidates, and a variety of different problems obtained from various clients. The invention allows an administrator to intelligently choose appropriate candidates to form various facilitator lead teams appropriate for particular client submitted problems. These various teams can then interact with various clients and client problems through the server, and efficiently suggest problem solutions, all while still maintaining confidentiality as desired.

FIG. 2 shows a server provided web page form that a candidate problem solver can use to provide a list of skills, personal background, and problem solving experience upon initial enrollment into the system.

FIG. 3 shows a server provided web page, which may be viewed from a dashboard web page, which shows the system administrator an overview of a particular candidate problem solver's completed list of skills, personal background, and problem solving experience. Additionally, this page can also allow the system to provide ratings on how the problem solver has performed on various problem solving teams since enrolling into the system.

FIG. 4 shows an overview of a server provided dashboard web page that allows a system administrator to see an overview of some or all of the various projects (client challenges), and their various statuses. The system can also provide a list of all available candidate problem solvers, team assigned problem solvers, facilitators, and other top level activity.

FIG. 5 shows an overview of a server provided dashboard web page that shows the team formation progress, or active team progress, for various projects or problems for a particular client. Here the administrator can pick a particular client submitted problem and form or manage various teams that can be assigned to this particular problem.

FIG. 6 shows an overview of a server provided dashboard web page that allows the system administrator to intelligently choose a team facilitator from the list of candidate problem solvers and facilitators, as well as to intelligently choose suitable team members. Here team members can be chosen based on a computer search of their relevant skills and background, as well as other criteria.

FIG. 7 shows how the administrator can invite candidate problem solvers or facilitators to join a particular team by sending an email from the server provided dashboard.

FIG. 8 shows how a candidate problem solver or candidate facilitator can receive a server provided web page showing the non-confidential part of a particular client's problem statement, and can accept or decline a request that they be placed on a team to work on that particular problem.

FIG. 9 shows how generally after a candidate problem solver or facilitator has sent in a non disclosure agreement, and has been formally assigned to a team by the system administrator (often using the administrator's dashboard web pages) the system will then send the confidential part of the client problem statement to the now active problem solver or facilitator, along with additional attachments and criteria as needed. This information can be delivered to a set of server provided project team workspace webpages, here called a “Thinkspace”.

FIG. 10 shows a server provided client web page, here called an “Open Innovation Portal”. Here a client can input new questions (“challenges”), and check on the status of the client's particular challenges (problems).

FIG. 11 shows another server provided client “Open Innovation Portal” workspace web page. Here the client is monitoring the status of two of the client's problems.

FIG. 12 shows another server provided client “Open Innovation Portal” workspace web page. Here the client is answering a question sent in from one of the teams.

FIG. 13 shows another server provided client “Open Innovation Portal” workspace web page. Here the client is reviewing the status of a number of previously asked and answer team questions regarding the client's project.

FIG. 14 shows another server provided client “Open Innovation Portal” workspace web page. Here the client is reviewing a team's reiteration of the client's original problem statement, and in this example informing the team that their reiteration of the problem statement is correct.

FIG. 15 shows a server provided team “Thinkspace” workspace webpage, informing the various team members of important key due dates, as well as any changes in the status of the progress since that particular team member last logged in.

### DETAILED DESCRIPTION OF THE INVENTION

In one embodiment, the invention may be a computerized method of managing an improved confidential, moderated, crowdsourced problem solving process. The invention, which will typically be implement the invention's methods by software operating on at least one computerized server, such as an Internet web server, and/or associated database memory or database computer systems. The invention operates using databases that store information relating to variety of potential problem solvers, as well as information relating to various client (i.e. organizations requesting help to solve problems) problems.

To enhance confidentiality, generally the software will be configured to hide or obscure the identity of the various clients and the problem solvers from each other. Further, often the client problem statements will be divided into confidential part(s) and non-confidential part(s), and the confidential part of the client problem will generally not be disclosed to the problem solvers until appropriate non disclosure agreements or other assurance of confidentiality has been implemented (e.g. signed).

To help ensure that there is a proper match between the candidate problem solvers and a given client problem, along with the confidential and non-confidential parts of the problem statement, each client will generally also enter or submit a list of relevant problem skills, and any relevant problem solver exclusions (i.e. don't take a solver who was formerly working at competitor X, Y or Z, don't take from a solver working in a country with adverse intellectual property assignment laws, and so on). In some cases, the problem solver may also list problem solver inclusions or preferences (i.e. prefer computer industry experience). These client problem solver criteria can then be used by one or more computer processors operating on the system server or database system to perform at least a preliminary automated scan of the candidate problem solver database, and use relevant “hits” to in turn recommend promising individuals as candidate problem solvers or facilitators for that particular problem.

For many technical problems, it is often the case that multiple problem solvers may come up with a solution where only one problem solver, no matter how talented may be stuck. However at some point, a law of diminishing returns sets in where if the problem solving team has too many members, productivity starts to suffer. An overly large problem solving group can overwhelm the client by generating too many questions, and producing too many irrelevant solutions.

Based on experience, the inventors have found that for many problems, often a small group or team, such as 3 to 10 team members, and often four to six team members, is often the most productive team size. This is large enough to provide different perspectives, but small enough so that each team member still feels personally responsible for the outcome.

To help reduce burden on the client, based on experience, the inventors have also found that it is also often helpful to appoint an experienced team facilitator. The team facilitator can help bring new team members up to speed, answer routine questions, and optionally do a certain level of moderation of questions and communications to and from the client in order to ensure that the various team member's questions or communications to the client further the project without overly burdening the client.

Although many aspects of problem solver and facilitator selection, as well as team formation, can be handled by the invention's software in a fully or partially automated manner, often it is useful to have one or more higher, “second level of management” individuals involved in the team selection and monitoring process as well. Here this second level of management is termed the system administrators or “administrator(s)”.

The system administrators will generally review the list of client submitted problems, and select, from the automated problem solver suggestion list, those individuals that will eventually form online teams. The system administrators will often also choose a team facilitator from an automatically generated list as well. To facilitate this team formation and monitoring process, often it will be further useful for the invention's software to direct the server to provide a “dashboard” graphical user interface (GUI). Often this dashboard is provided in the form of various dashboard web pages. The dashboard GUI is designed to allow one or more high level system administrators to oversee the status of many problems and many clients at a glance, and see when the system is operating properly, and see when various corrections may be needed.

Here, for example, the dashboard GUI can give an overview of the various clients and various client problems, and for each problem also display a list of potentially matching problem solvers and facilitators. The dashboard can also provide at least some information or links to information pertaining to the problem solver and facilitator skills, personal background and problem solving experience.

The administrator can then use the system's dashboard GUI to form and manage various problem solving teams. Here, for example, the administrator can use the system's dashboard GUI to select a team facilitator to moderate the team's problem solving process, as well as various problem solver team members. Usually upon selection, either manually or automatically, the system can also allow the administrator to transmit an invitation to the selected individuals, often along with a non-confidential problem statement, and an NDA (non disclosure agreement) for the user to sign either manually or electronically.

The administrator can then chose among the selected candidates for retuned NDA, make any final team adjustments as needed, and then provide a confidential electronic workspace (often one or more server provided web pages) for the various team members (usually located in geographically diverse areas, and communicating in over the Internet) to use to coordinate work on that particular problem, inform the various candidates that they are now officially on the team, and also (usually through the team workspace) also provide the confidential portion of the problem statement to the team members. The system can then also provide a confidential client workspace for the problem.

Then, preferably using the team workspace, and preferably as moderated by the team facilitator, the team can ask the client various questions, optionally restate the original problem statement to ensure that the team understands the assignment properly, and also submit proposed solutions to the client. If the client accepts the solution or solutions, the client can then, often in exchange for pre-agreed payments, then transmit intellectual property release forms to the team, and release funds once the release forms have been received.

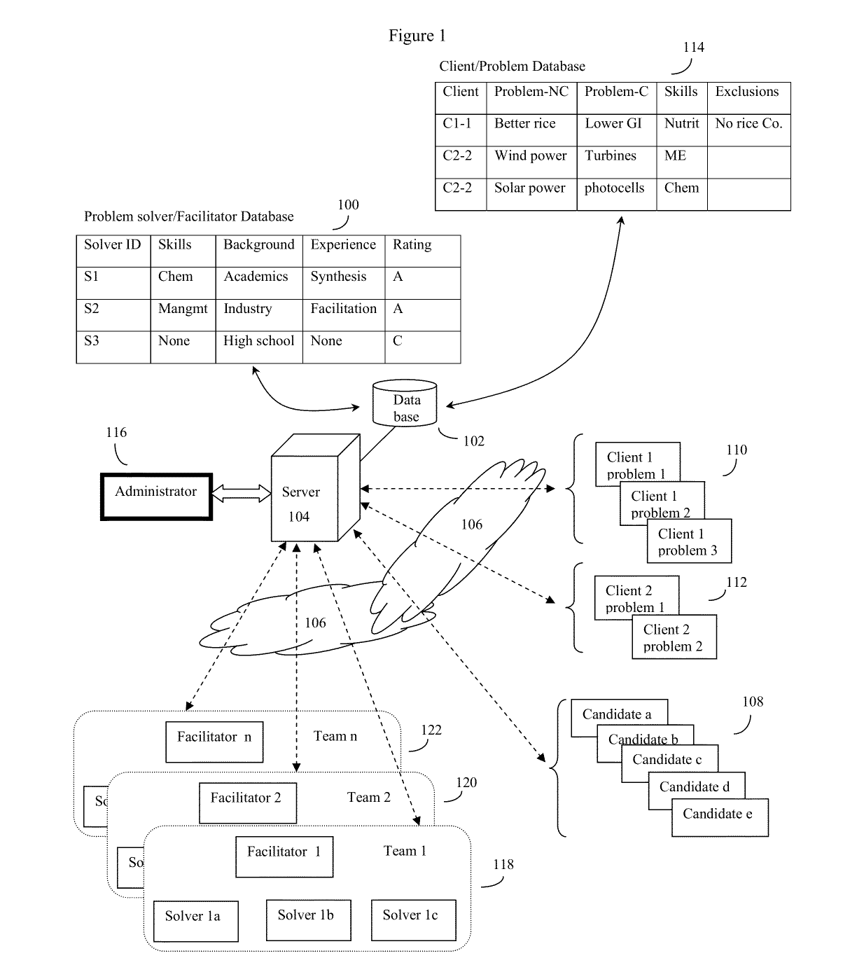

FIG. 1 shows an overview of how the invention's Internet server based system can assemble information from a variety of potential problem solver candidates, and a variety of different problems obtained from various clients, and allow an administrator to intelligently choose appropriate candidates to form various facilitator lead teams appropriate for particular client submitted problems. The various teams can then interact with various clients and client problems through the server, and efficiently suggest problem solutions, all while still maintaining confidentiality as desired.

In one embodiment, the invention manages various confidential, moderated, crowdsourced problems by storing data pertaining to a plurality of problem solvers, facilitators and a list of their skills, personal background, and problem solving experience (100) in a crowdsource computer database (102). This database, alternatively called a problem solver/facilitator database, is often connected to an Internet or other network server (104). This server (104) will often communicate with various computerized devices operated by various clients, problem solvers, facilitators, and administrators over a computer network such as the Internet (106). These computerized devices may be desktop computers, laptop computers, tablet computers, smartphones and the like. These computerized devices usually will be equipped with at least one processor, memory, displays, input capability, network connectivity, and various software such as operating system software, web browsers, apps, and the like.

When used in a server embodiment, the server (104) will often communicate with various system users via various methods, including email, SMS messaging, social network messaging, screen page information sent to various apps (e.g. smartphone or tablet computer apps), or often by serving various web pages or other screen pages that in turn can be read by web browsers, apps or other programs running on the user's various computerized devices.

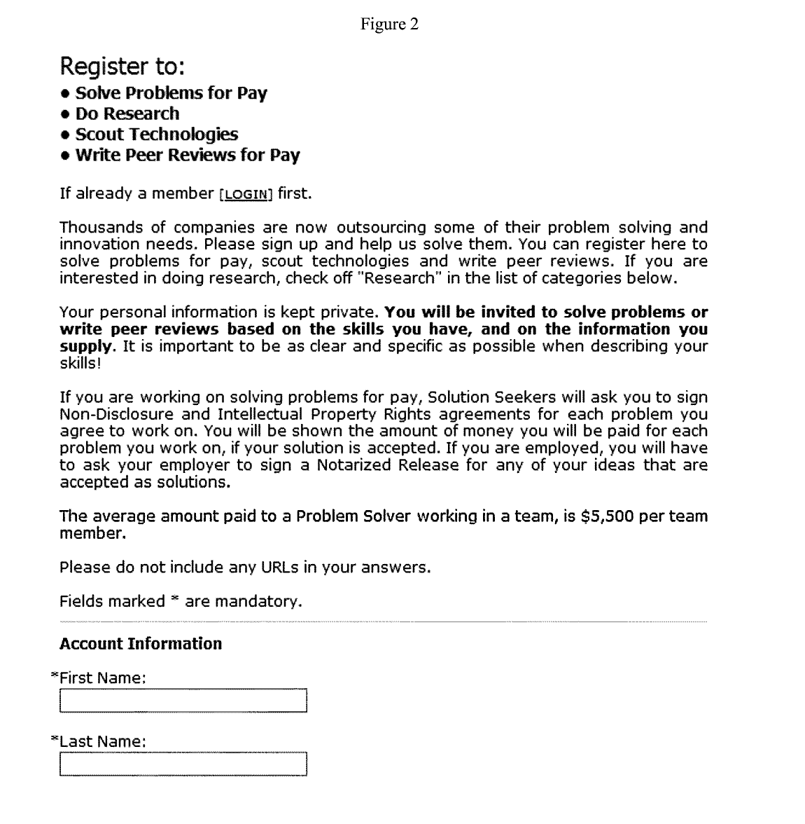

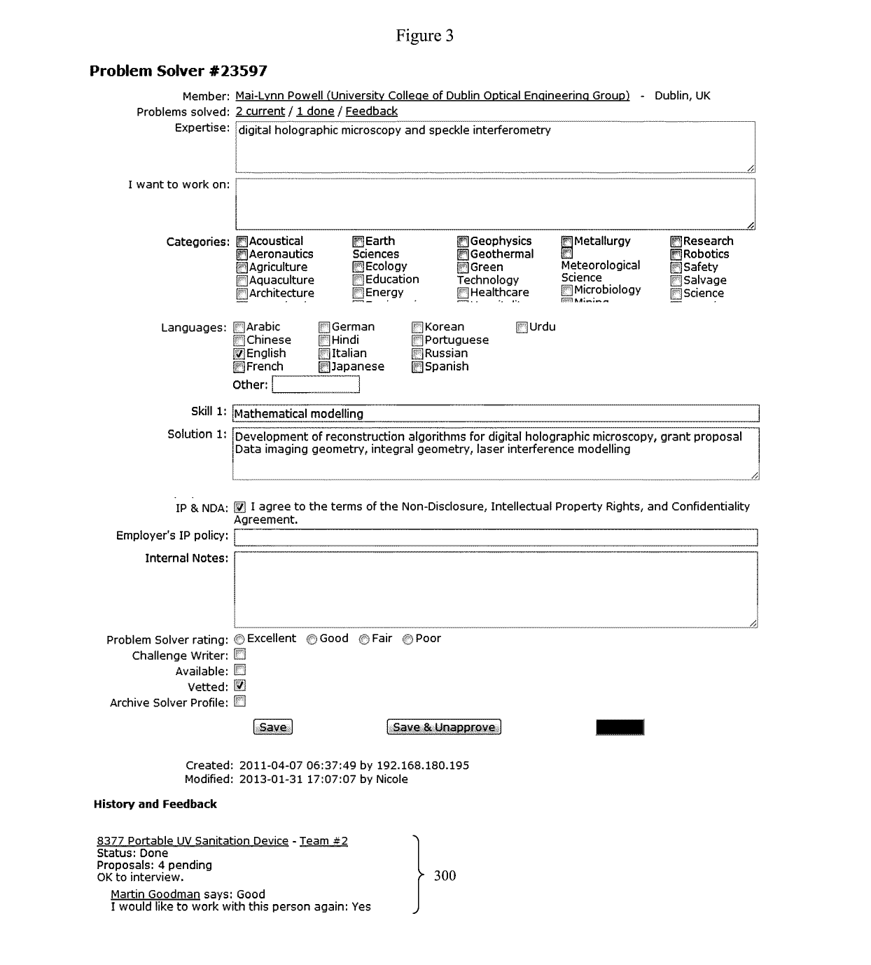

To provide a list of potential problem solvers and facilitators, often various candidate individuals (108) will be encouraged to view introductory web pages provided by the server (or other server) (104), often by advertising or other method. Those individuals who are interested may sign up by, for example, filing out various server provided web page forms. Here a candidate problem solver or facilitator can, for example provide a list of skills, personal background, and problem solving experience, and request to be enrolled into the system. An example portion of such a candidate sign-up web page (here focused in the introduction) is shown in FIG. 2. Some of the various skills and background that a candidate can enter into this page are shown in the top part of FIG. 3.

Various clients (110), (112), who often will be various organizations that have various problems to solve, will also be encouraged to enroll in the system, often by a similar advertising and web page sign-up process. To enhance security, often all web pages provided by the system be may secure or encrypted web pages (e.g. https web pages, and the like). Alternatively, non-web page based methods of network communication may also be used.

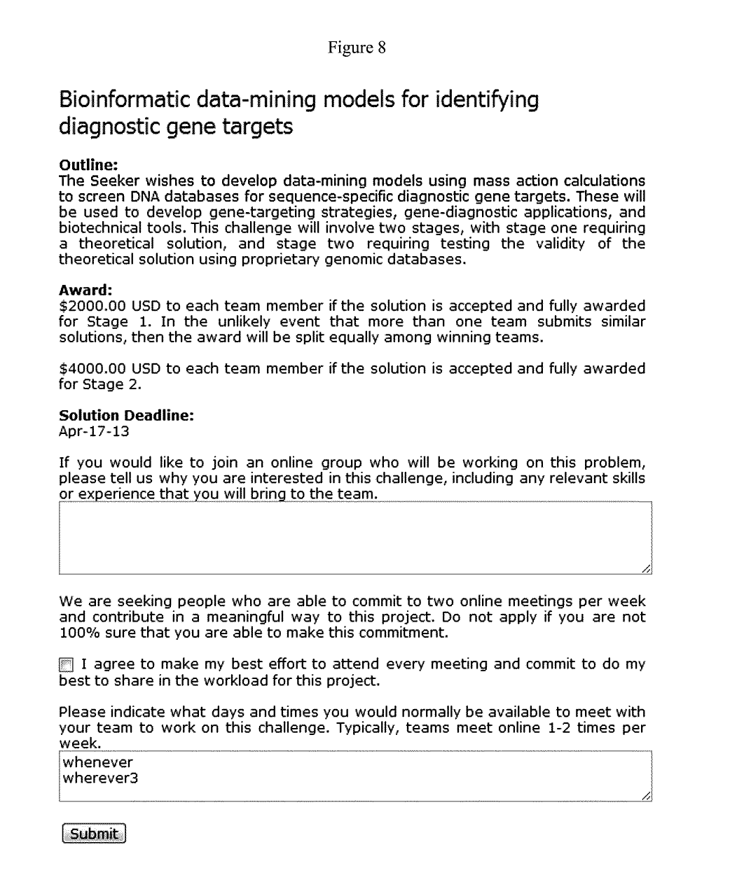

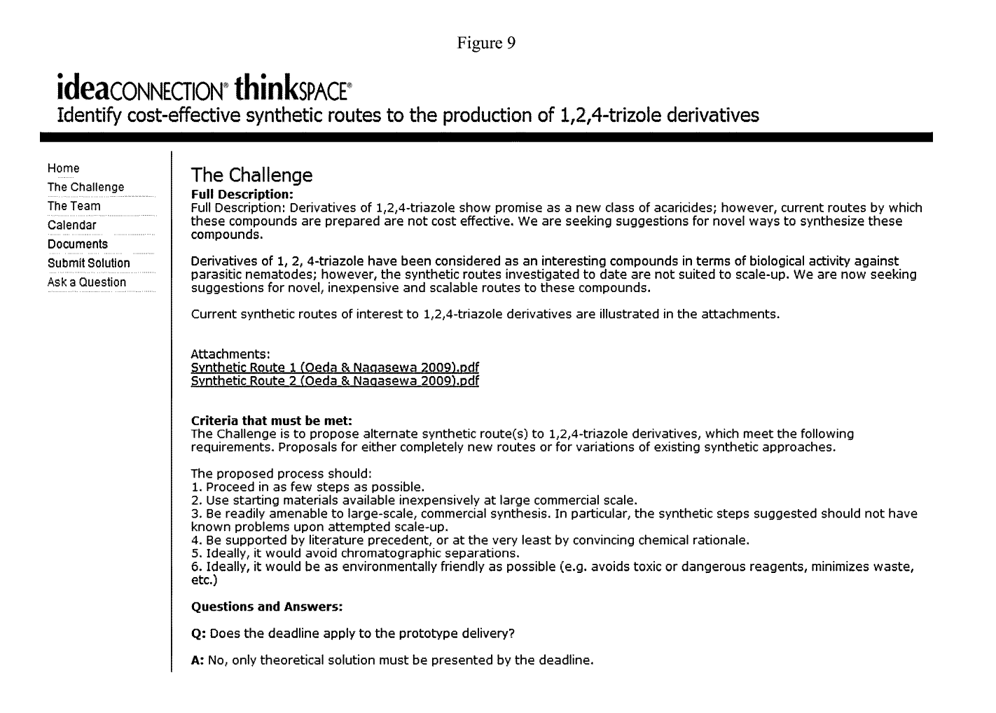

These various clients (110), (112) will enter in various problems to solve in the form of various problem statements. These problem statements will usually have a non-confidential part (e.g. perhaps describing the general field and type of problem but leaving out important and confidential details) and a confidential part (e.g. enough detail to allow the problem solvers to produce meaningful and useful solutions for the problem). The system will then store these various problem statements, along with the statement non-confidential part and confidential part, and other information such as a solution payment amount, explicit or default list of relevant problem solver skills, and list of problem solver and facilitator inclusions or exclusions (e.g. don't use a problem solver or facilitator who is also a current or former employee of certain competitor organizations), and information about the associated client in the system's problem computer database (114). Some examples of these problem statements can be seen in FIG. 8 (non-confidential part) and FIG. 9 (confidential part).

Once this is done, the system can then be used to solve a given problem by, for example, using the particular problem in question (e.g. problem C2-2 from database 114) and at least one computer processor (often associated with either database 102 or server 104) to search the problem computer database (114) for the list of explicit or default list of problem skills, as well as list of problem solver and facilitator inclusions or exclusions. Here for example, if we use the solar power problem C2-2 (i.e. problem 2 from client 2) as an index to database (114) we see that the list of solar power problem skills calls for chemistry (Chem) skills, and there are no inclusions or exclusions listed.

Now that we (the invention's computer system) knows that the list of relevant problem skills for this particular problem C2-2 includes chemistry skills, the system can then use this list of relevant problem skills, and list of problem solver facilitator inclusions or exclusions (in this example there are none) as an index to the crowdsource computer database (i.e. the problem solver/facilitator database 100) to select those matching problem solvers or matching facilitators that match these lists.

In this example when the system searches for problem solvers with chemistry skills, it sees that the problem solver with the ID “S1” has chemistry skills, and there are no issues with respect to problem solver exclusions or inclusions. The computerized system can then automatically register a “hit” or “match”, pull out problem solver S1 (and other problem solvers with similar skills) from database (100), and display these “hits” in an administrator dashboard, or even automatically recommend inclusion of this particular problem solver in a team for this problem, if this automatic team formation process is desired.

The matching of problem solvers and facilitators with problems may, in some embodiments, be entirely automatic. However in a preferred embodiment, experienced human intelligence, usually provided by one or more system administrators will often be desirable in order to ensure that an optimized team is created for each problem. Some use of human intelligence or oversight is desirable because team formation often involves knowledge of business practices, human factors analysis, technology, and other issues. Thus it is often preferable to choose system administrators who are experienced in business and research management, and even if the initial team member suggestions are automatically generated, allow at least some degree of human oversight and approval over the team formation process.

In order to allow a human system administrator to apply reasoned business and technology oversight to the composition of team members, often the system may display a list of list of matching problem solvers and facilitators in a dashboard graphical user interface (GUI) display screen or screens. This dashboard GUI will often also show at least some information, or links to information, pertaining to that team member's skills, personal background and problem solving experience.

Often the server (104) may do this by providing various dashboard display screens, such as dashboard web pages to one or more human administrators (116). These human administrators (116) along with other individuals using the system (e.g. clients, problem solvers, facilitators and the like) will of course interact with server (104) through various local computerized devices, and computer networks such as the Internet (106) as previously discussed.

In some embodiments, the administrator dashboard will be provided as a plurality of web pages, usually again generated by server (104). The dashboard may consist of one or more index pages or screens that give the administrator an overview into a large number of system functions, as more detailed pages or screens that allow the administrator to zoom into various parts of the system, and monitor or alter team member selection and team composition as administrator judgment or system policy dictates.

An example of one type of administrator overview dashboard web page, provided by server (104), is shown in FIG. 3. This particular dashboard page gives the system administrator (116) a detailed overview of a particular candidate problem solver's (108) completed list of skills, personal background, and problem solving experience. Some of this information may have been obtained from the original problem solver's application page previously shown in FIG. 2, and some may have been added since then. Additionally, the FIG. 3 dashboard page can also allow the system or administrator to view or provide ratings on how the problem solver has performed on various project teams since enrolling into the system.

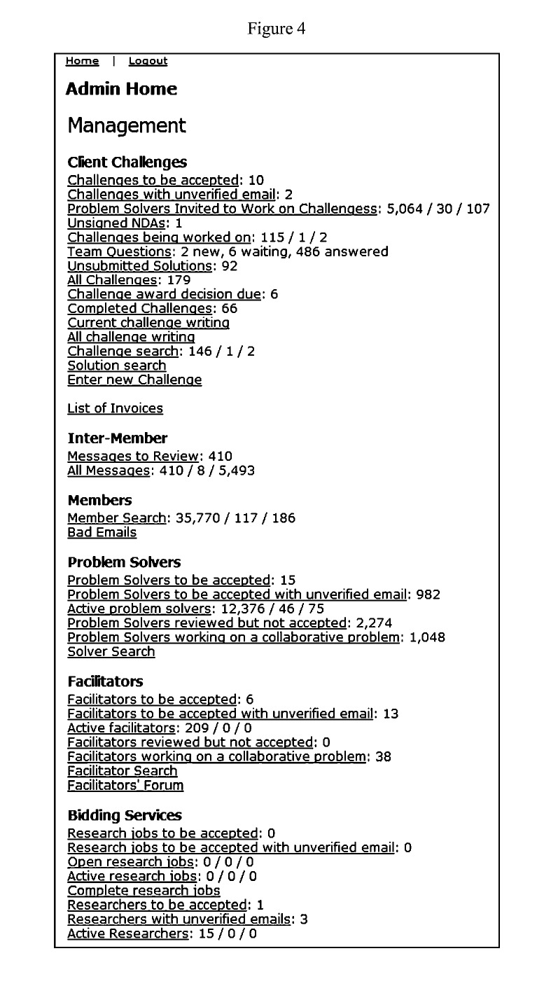

FIG. 4 shows an overview of a server (104) provided top-level dashboard web page that allows a system administrator (116) to see an overview of all of the various projects (client challenges), their status, list of all available candidate problem solvers or assigned problem solvers, facilitators, and other top level functions.

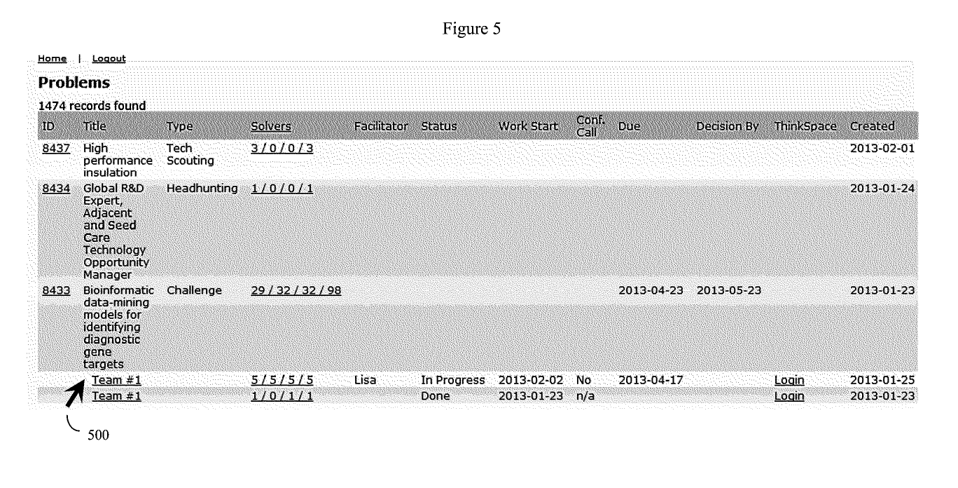

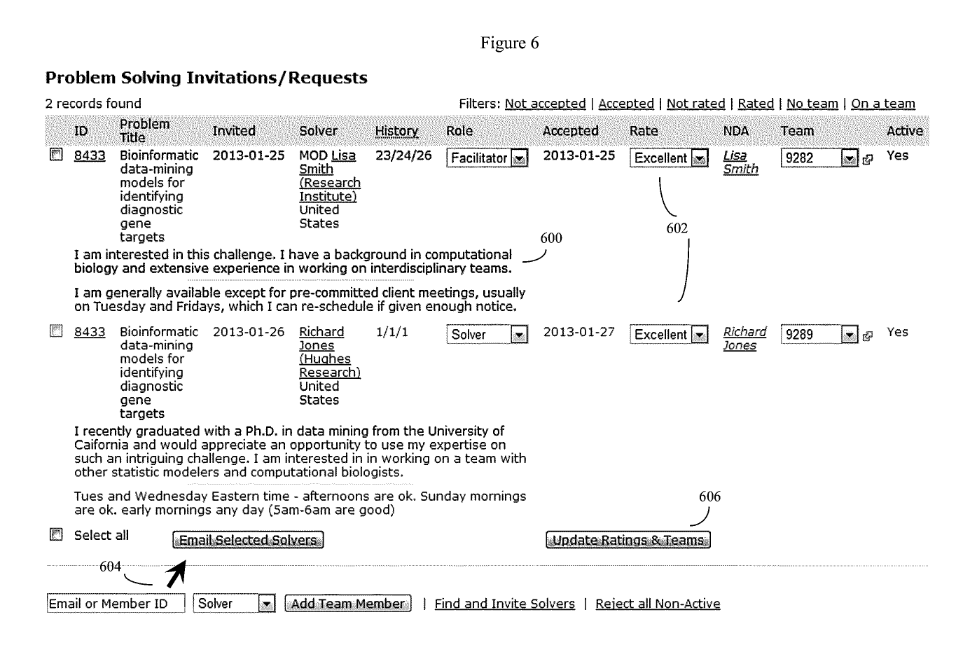

FIG. 5 shows an overview of a server (104) provided dashboard web page that shows more details of the team formation progress or team progress for several projects or problems (e.g. project IDs 8437, 8434, and 8433). At this level of the dashboard, the administrator (116) can pick a particular client submitted problem, and form or manage various teams that can be assigned to this particular problem. Here for example, the administrator is choosing to examine project 8433 in more detail, and work on team formation for this project. The administrator is thus clicking on Team #1 for project 8433 (500), and the system will then take the administrator to a more detailed dashboard page focusing on this particular team, which is shown in FIG. 6.

Note also that FIG. 5 is showing more than one project. This illustrates another aspect about the dashboard GUI, which is that it can be configured to display the status of more than one problem at the same time, as well as other information such as a list of one or more teams associated with each problem, and team status information

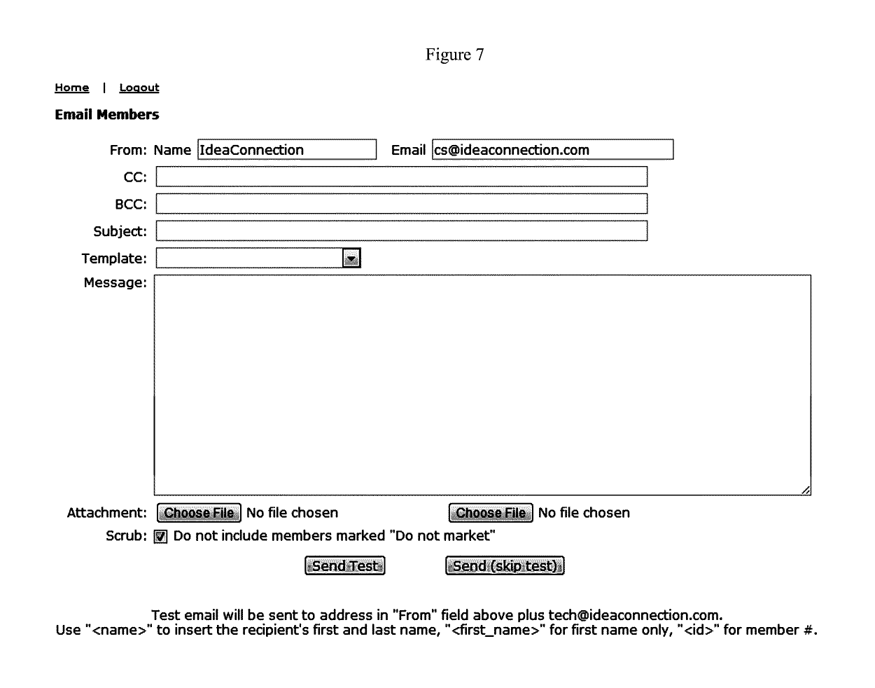

As previously discussed, for each team, the administrator (116) may often use one or more dashboard pages (dashboard GUI) to select at least one candidate facilitator to moderate the problem solving process, as well as a number (typically 2-10, and often 3-6) candidate problem solvers to participate in the problem solving process as a team. In this example, assume facilitator Lisa has been provisionally selected to be facilitator, and an invitation to participate may have previously been transmitted to Lisa (for example by an invitation email shown in FIG. 7). However the team formation process is still “In Progress”. So was Lisa interested in participating? How about other potential team problem solvers? Are they the best available team for this problem?

FIG. 6 shows an overview of a server (104) provided dashboard web page that allows the system administrator (116) to intelligently choose a team facilitator from the list of computer proposed candidate problem solvers and facilitators, as well as to intelligently choose suitable team members. As previously discussed, here team members are often chosen based on an initial computer search of their relevant skills and background, as well as other criteria which may be chosen according to administrator judgment.

In terms of automatic or semi-automatic team member selection, please return to FIG. 1 for a moment. The computer system processor(s) (e.g. the processor(s) for database 102 or server 104) may in some embodiments be programmed to suggest one or more candidate facilitators for a given project. These facilitators may often be selected from database (100) based on some prior management or project facilitation experience, as well as various system ratings accumulated over time on the system. In this example, the computer system might automatically screen database (100), and automatically propose solver S2 as a potential facilitator based upon this individual's management background, industry experience, prior facilitation experience, and good ratings. By contrast, individual S3 would be unlikely to be automatically selected by the system as a possible candidate for either the problem solver or facilitator roles, due to lack of skills, appropriate background, relevant experience and/or poor system rating.

By using the dashboard screen shown in FIG. 6, the administrator can view more information about the manually or automatically recommended facilitators and problem solvers for a given project, select them, and invite them to participate in a given project. Once initially selected as a potential project participant, the dashboard screen can then allow the administrator to send an invitation to the potential participant via email, SMS, web page or other communications method. In this example, the system is set up to facilitate email invitations (604), which are shown in FIG. 7. In FIG. 6, assume that Lisa was previously invited to be a facilitator, and her indication of interest is shown as (600).

FIG. 7 shows how the administrator can invite candidate problem solvers or facilitators to join a particular team by sending an email from the server (104) provided dashboard. To maintain confidentiality, the invitation will often also contain, or may be closely followed or be preceded by, a non disclosure agreement (NDA). This NDA may be provided either as a document for the individual to print out, sign, scan, and forward back, as an electronically signed document, or even by a simple “click for agreement” interface depending upon various legal considerations and the legal jurisdiction involved. In this example, the system provides an email form along with various suggested templates and a list of email addresses (often obtained from database (100) to facilitate notification.

Along with the invitation, the system can also provide the candidate problem solver or candidate facilitator with the non-confidential part of the problem statement. This can be provided by a web page generated by server (104), or by other methods. An example of the non-confidential part of the problem statement is shown in FIG. 8.

FIG. 8 shows an example of a web page that a candidate problem solver or facilitator can receive from server (104). This shows the non-confidential part of a particular client's problem statement. If interested, the candidate can use their computerized device to respond and request that they be placed on a team to work on that particular problem.

Once the candidate problem solver of facilitator sends in their NDA, and upon receipt of their signed NDA agreements the administrator (116) can then use the dashboard GUI to select at least one interested candidate facilitator usually several interested candidate problem solvers to constitute a problem solving team for that particular problem. This is shown in FIG. 1 as team 1 (118). The system allows the administrator to create many other such teams, such as team 2 (120) and on up to team “n” (122). Depending upon project priority or complexity, one or more teams may be assigned to any given project.

As a general rule, each team may comprise at least one chosen facilitator, and often 2-10 chosen problem solvers. In the event that a team member vacancy occurs, new team members may be appointed by the administrator. If a facilitator vacancy occurs, the administrator may either appoint a new administrator, promote an existing solver to also take on the role of facilitator, or even temporarily step in as a facilitator. Thus the roles of problem solver and facilitator, although often handled by different individuals, need not always be handled by different individuals. In any event, once a team has been selected and is ready to go, the system, either automatically or under administrator control, will generally transmit a team formation message to that particular team. Often along with the team formation message, in some embodiments the system may also provide a confidential electronic team workspace for the problem. In essence this confidential electronic team workspace can also consist of a plurality of team oriented web pages, usually with some sort of security feature such as passwords, and again may often be delivered using one or more web security mechanisms. Other delivery and security mechanisms, such as using apps, biometric sensors (e.g. fingerprint sensors) and the like can also be used.

In a preferred embodiment, however, the system may use web server (e.g. 104) to provide both the team workspace (e.g. web pages for team 118) and also client workspaces (to be discussed) as one or more web pages or app screens over the Internet. Generally the team members and clients will interact with the team workspace and client workspace using web browsers or application software running on various team member and client computerized devices connected to the Internet, as previously discussed.

In some embodiments, the system (e.g. server 104) will also provide each individual problem solver and facilitator with their own home page as one or more web pages or app screens. This is useful, because then the various problem solvers and facilitators can log in to the server (104) over the Internet (106), and use web browsers or application software running on their respective computerized devices to receive progress updates. For example, these home pages can display a list of problems that each individual problem solver or facilitator has been invited to solve, as well as the problems that they are currently working on.

FIG. 9 shows how generally after a candidate problem solver or facilitator has sent in a non disclosure agreement, and has been formally assigned to a team (118) by the system administrator (116) (often using the administrator's dashboard web pages) the system will either automatically or under administrator control then send the confidential part of the client problem statement (from database 114) to the now active team problem solver or facilitator, along with additional attachments and criteria as needed. This additional information can, for example, be delivered to a set of server (104) provided project team workspace webpages, here called a “Thinkspace”. Note that in FIG. 9, the system does not reveal the identity of the client to the team.

In some embodiments, the efficiency of the team problem solving process may be further enhanced by having the team first “restate” the client's problem before then commencing detailed work on the problem. To do this, the system may formally require this as a project do to item, and require that the team transmit such a restatement, and that the client formally either approve or modify the restatement before the team then commences further work on the problem. Such restatement can be useful, because it can help flush out areas where the problem may have originally been stated ambiguously, where insufficient information may have been provided, or where the team has simply misunderstood one or more aspects of the problem.

In this embodiment, after providing the confidential part of the problem statement, the system software may further require that the facilitator work with the team to obtain team restated versions of the original problem statement, moderate as necessary, and then transmit this restated and optionally moderated version of the original problem statement back to the client, along with other team questions, usually by using the team workspace provided by server (104). When this is done, the client will see the restated versions on their own server provided client workspace, affirm, correct or answer questions as needed, and then use the client's server (104) provided workspace to transmit these client responses back to the team's workspace.

More specifically, in some embodiments, after providing the confidential part of the problem statement, the system will require additional steps, such as obtaining a facilitator moderated problem restatement from the team (e.g. 118), and using the team workspace to transmit the problem restatement to the client workspace. The system will also require that the client (e.g. 110) use the client workspace to transmit client approval, modification, or rejection of this restatement to team (e.g. 118's) workspace.

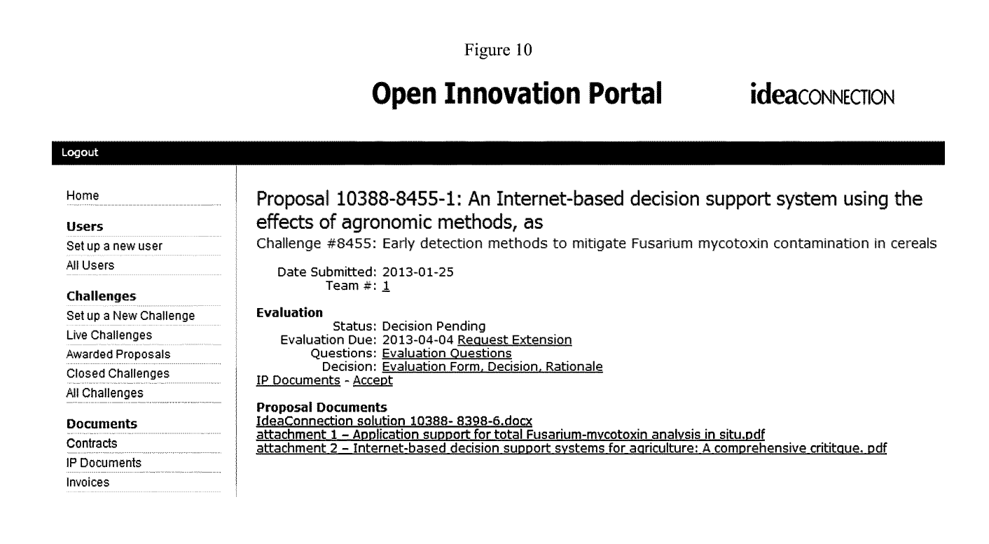

FIG. 10 shows a server (104) provided client web page, here called an “Open Innovation Portal”. Here a client can input new problems (“challenges”), and check on the status of the client's previously submitted problems (challenges).

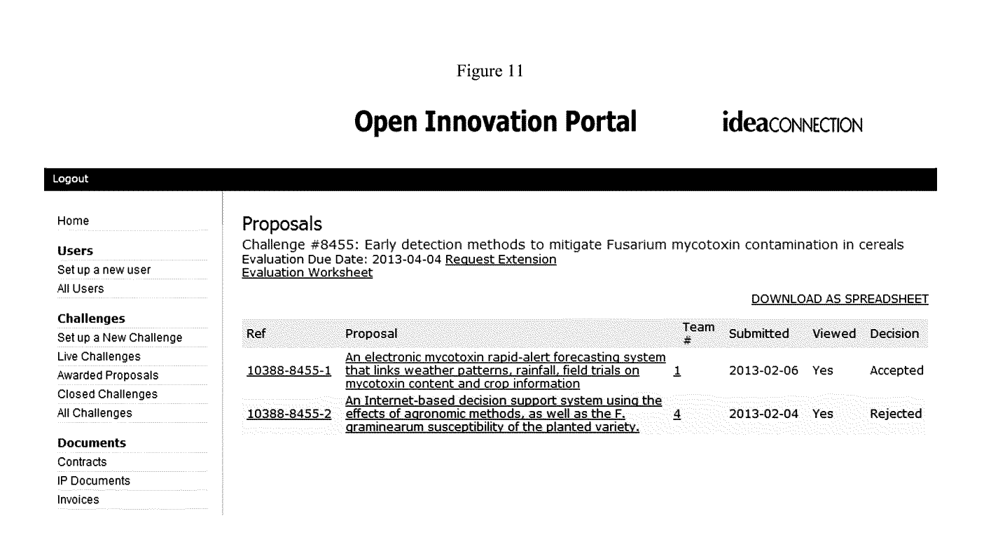

FIG. 11 shows another server (104) provided client “Open Innovation Portal” workspace web page. Here the client (e.g. 110) is monitoring the status of two of the client's project proposals (problems). One may for example be handled by team 1 (120), and the other by team 4 (122).

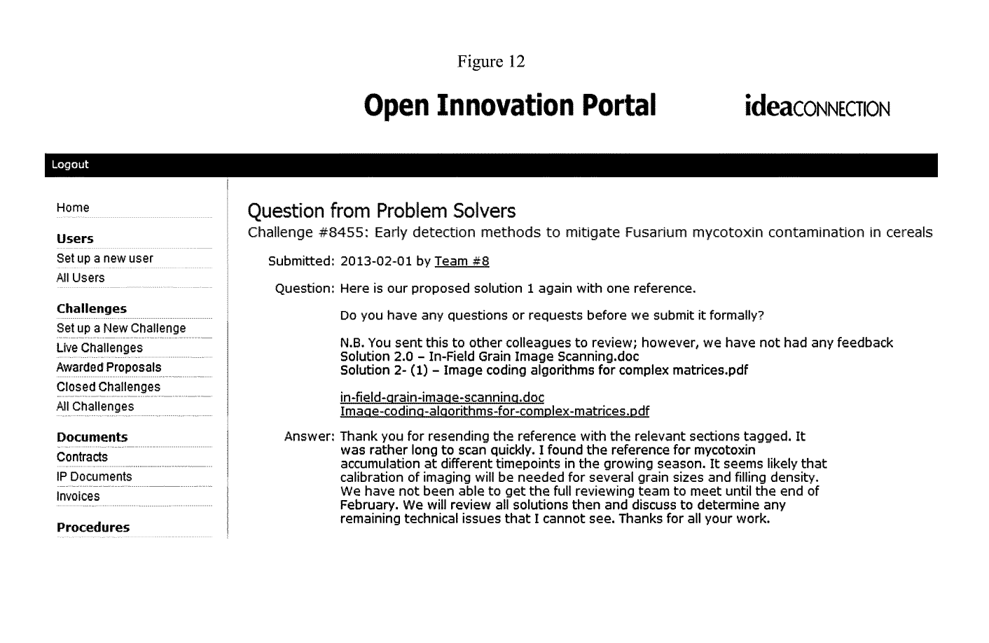

FIG. 12 shows another server provided client “Open Innovation Portal” workspace web page. Here the client is answering a question sent in from one of the teams. Note that in this embodiment, the system also does not reveal the identity of the team members to the client.

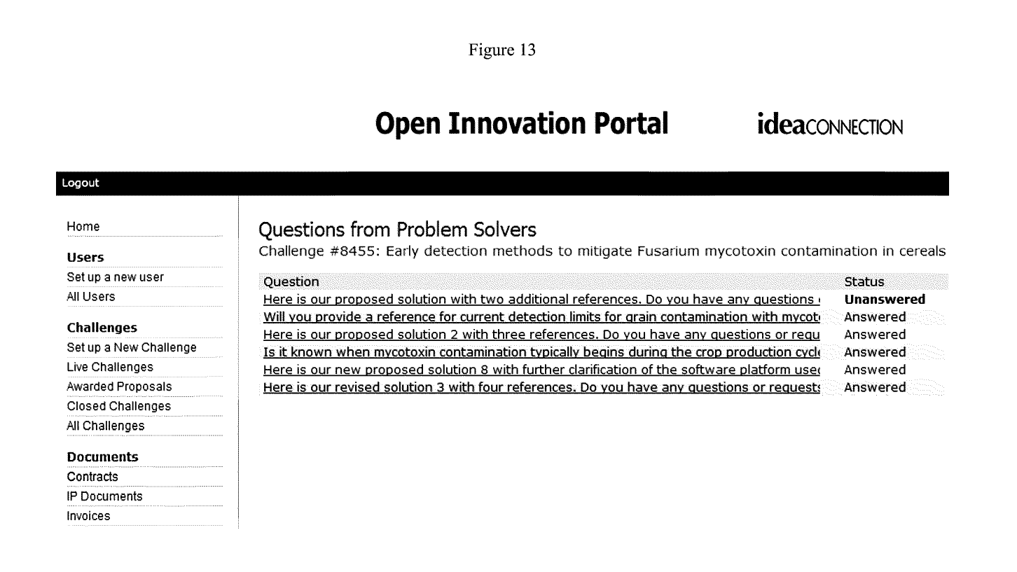

FIG. 13 shows another server provided client “Open Innovation Portal” workspace web page. Here the client is reviewing the status of a number of previously asked and answer team questions regarding the client's project.

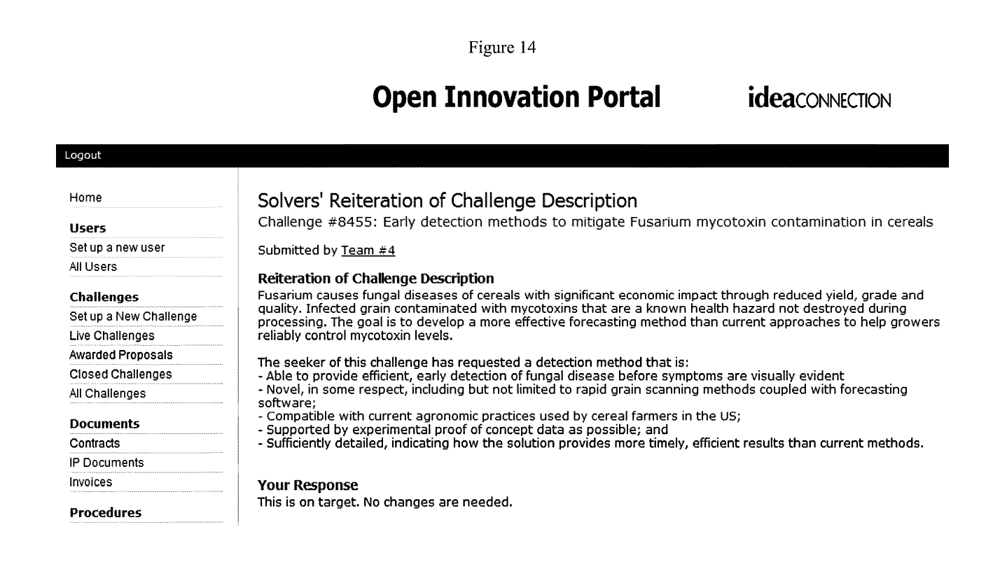

FIG. 14 shows another server provided client “Open Innovation Portal” workspace web page. Here the client is reviewing a team's reiteration of the client's original problem statement, and in this example informing the team that their reiteration of the problem statement is correct.

In some embodiments, after the optional problem restatement or reiteration has been provided and accepted or modified, the system server (104) may additionally automatically require (or at least recommend) that the team further schedule at least one voice communications session between the team and their client. Here, to preserve anonymity, this voice communication session may be mediated by server (104), or by other conferencing system that can obscure the identity of the client from the team members, and the identity of the team members from the client. Although often team members may chose not to be anonymous with respect to each other, if this option is required, the system may also be programmed to require mutual team member anonymity as well. Experience has shown that in this context, even a single voice communications session, often about an hour or so in length, can help flush out and resolve issues that otherwise may take weeks of electronic text based communications to resolve.

Usually after the system server (104) has provided the confidential part of the problem statement to the various team members, the team workspace can also be used to perform additional functions, such as transmitting one or more team proposed (and preferably facilitator approved) problem solutions to the client. Here, for example, the server (104) may deliver such team proposed problem solutions to one or more client workspace web pages.

Team members (e.g. members of Team 118) will may additionally use the server (104) to help schedule online meeting dates, facilitate group chat discussions (either written, audio, or audio video), maintain project progress reminders and milestones, and the like. Although in some embodiments, the system server (104) software may be configured to require that all communications between the team and the client be approved by the team facilitator, in other embodiments, the system will permit non-facilitator approved communication, according to system policy and client, administrator, or facilitator preferences). Communications between team members may also be done less formally as desired.

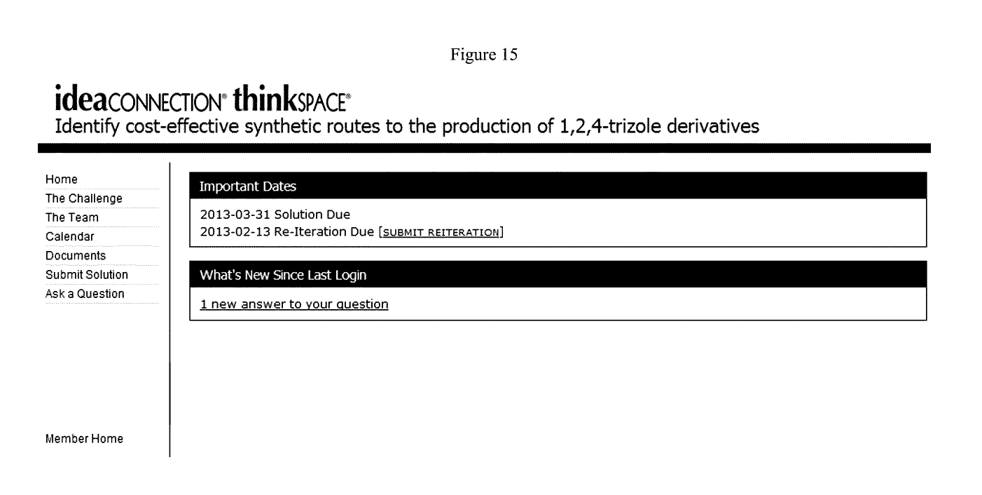

FIG. 15 shows a server provided team “Thinkspace” workspace webpage, here informing the various team members of important key due dates, as well as any changes in the status of the progress since that particular team member last logged in.

Generally, once the client has reviewed the team's proposed solution, and if the client finds it to be acceptable, then the client will be expected to use the client's web portal to inform the server (104) to release any funds allocated to reward or pay the team for its successful efforts.

If the client has also previously stipulated that the client wishes to obtain intellectual property rights for any accepted team proposed solution, then prior to any funds being released, server (104) may also transmit unsigned intellectual property (IP) release forms to the various team members. In this situation, the system will generally be programmed to then release fund to the various team members when the client or administrator determines that the signed IP release forms have been received properly and are in order. Funds may then be dispersed by the system via various types of electronic funds transfer, or even by direct check mailing or cash, as desired.

It is to be expected that once at least the unsigned IP release forms have been received by the various team members, then the identity of the client may or may not be revealed by these IP release forms. Similarly once the client receives the team's signed IP release forms, then the identity of the various team members may be revealed to the client. However this is not necessarily obligatory. For example, in some embodiments, IP rights may be released to a third party in trust for the client, in which case confidentiality may be preserved for so long as the third party trust operates. Thus the identity of the client and team members may, in some embodiments, be preserved indefinitely.

In some embodiments, in order to improve the efficiency of the system for subsequent teams and problems, the system will then require mutual evaluations for some or all team members. These evaluations, generally on a per-each problem solver or facilitator basis, can then be stored in the Problem solver/Facilitator or “crowdsource” database (100). This can be seen as the ratings column in FIG. 1 (100), the History and Feedback section in FIG. 3 (300), and the ratings drop down box in FIG. 6 (602) and update input (606).

Other embodiments of the invention are also possible. Some of these are discussed in more detail in parent provisional application 61/756,596, the contents of which are incorporated herein by reference.

1. A computerized method of managing a confidential, moderated, crowdsourced problem solving process, said method comprising:
storing a plurality of problem solvers, facilitators and a list of their skills, personal background, and problem solving experience in a crowdsource computer database;
storing a plurality of problem statements, each problem statement having a non-confidential part, a confidential part and a solution payment amount, each problem statement further having an explicit or default list of relevant problem skills, and a list of problem solver and facilitator inclusions or exclusions, and an associated client in a problem computer database;
solving at least one problem by:
using said problem to search said problem computer database for said list of explicit or default list of problem skills, and list of problem solver and facilitator exclusions;
using said list of relevant problem skills, and list of problem solver facilitator exclusions as an index to said crowdsource computer database to select matching problem solvers or matching facilitators that match said lists;
displaying said list of matching problem solvers and facilitators in a dashboard GUI, along with at least some information or links to information pertaining to their skills, personal background and problem solving experience;
using said dashboard GUI to select at least one candidate facilitator to moderate said problem solving process, and a plurality of candidate problem solvers to participate in said problem solving process, and transmit a solving invitation comprising the non-confidential part of said problem statement and unsigned NDA agreements to said at least one candidate facilitator and plurality candidate problem solvers;
providing a confidential electronic team workspace for said problem;
providing an electronic client workspace for said problem;
providing the confidential part of said problem statement;
using said workspace to transmit team proposed and facilitator approved potential problem solutions to said client workspace;
wherein if said client accepts said potential problem solution, and wishes to obtain IP rights prior to release of said solution payment amount, transmitting unsigned IP release forms to said team, and upon receipt of signed IP release forms, then transmitting said solution payment amount to said team.

2. The method of claim 1, wherein at least prior to transmission of said unsigned IP release forms, the identity of said client is not disclosed to said team, and the identity of the team facilitator(s) and team problem solvers is not disclosed to said client.

3. The method of claim 1, wherein after providing the confidential part of said problem statement, further performing the steps of:
obtaining a facilitator moderated problem restatement from said team, and using said team workspace to transmit said problem restatement to said client workspace; and
using said client workspace to transmit client approval, modification, or rejection of said restatement to said team workspace.

4. The method of claim 3, wherein after providing said problem restatement to said client, further scheduling at least one voice communications session between said team and said client.

5. The method of claim 1, wherein after providing the confidential part of said problem statement, further performing the steps of:
obtaining facilitator moderated problem questions from said team, and using said team workspace to transmit said facilitator moderated questions to said client workspace;
obtaining client answers from said client, and using said client workspace to transmit said client answers to said team workspace.

6. The method of claim 1, further obtaining mutual evaluations of all team members, and for each problem solver or facilitator, and further storing said mutual evaluations in said crowdsource computer database.

7. The method of claim 1, wherein said dashboard GUI further displays the status of a plurality of problems originating from at least one client, along with a list of one or more teams associated with each problem, and team status information.

8. The method of claim 1, further using a web server to provide said team workspace and said client workspace as one or more web pages or app screens over the Internet, and wherein said team members and said clients interact with said team workspace and said client workspace using web browsers or application software running on team member or client computerized devices connected to the Internet.

9. The method of claim 1, further using a web server to provide each individual problem solver and facilitator with their own home page as one or more web pages or app screens over the Internet using web browsers or application software running on each problem solver's or facilitator's computerized device connected to the Internet;
said home page comprising a list of problems that each individual problem solver or facilitator has been invited to solve, and problems that they are currently working on.

10. The method of claim 1, wherein said teams comprise one facilitator and between 2-10 problem solvers.

11. The method of claim 1, wherein upon receipt of signed NDA agreements from said at least one candidate facilitator and plurality of candidate problem solvers, further using said dashboard GUI to select at least one candidate facilitator and plurality of candidate problem solvers to constitute a problem solving team comprising at least one chosen facilitator and a plurality of chosen problem solvers, and transmitting a team formation message to said team.

12. A computerized method of managing a confidential, moderated, crowdsourced problem solving process, said method comprising:
storing a plurality of problem solvers, facilitators and a list of their skills, personal background, and problem solving experience in a crowdsource computer database;
storing a plurality of problem statements, each problem statement having a non-confidential part and a confidential part and a solution payment amount, each problem statement further having an explicit or default list of relevant problem skills, and list of problem solver and facilitator inclusions or exclusions, and an associated client in a problem computer database;
solving at least one problem by:
using said problem to search said problem computer database for said list of explicit or default list of problem skills, and list of problem solver and facilitator inclusions or exclusions;
using said list of relevant problem skills, and list of problem solver facilitator inclusions or exclusions as an index to said crowdsource computer database to select matching problem solvers or matching facilitators that match said lists;
displaying said list of matching problem solvers and facilitators in a dashboard GUI, along with at least some information or links to information pertaining to their skills, personal background and problem solving experience;
wherein said dashboard GUI further displays the status of a plurality of problems originating from at least one client, along with a list of one or more teams associated with each problem, and team status information;
using said dashboard GUI to select at least one candidate facilitator to moderate said problem solving process, and a plurality of candidate problem solvers to participate in said problem solving process, and transmit a solving invitation comprising the non-confidential part of said problem statement and unsigned NDA agreements to said at least one candidate facilitator and plurality candidate problem solvers;
upon receipt of signed NDA agreements from said at least one candidate facilitator and plurality of candidate problem solvers, further using said dashboard GUI to select at least one candidate facilitator and plurality of candidate problem solvers to constitute a problem solving team comprising at least one chosen facilitator and a plurality of chosen problem solvers, and transmitting a team formation message to said team;
providing a confidential electronic team workspace for said problem;
providing an electronic client workspace for said problem;
providing the confidential part of said problem statement;
obtaining a facilitator moderated problem restatement from said team, and using said team workspace to transmit said problem restatement to said client workspace; and
using said client workspace to transmit client approval, modification, or rejection of said restatement to said team workspace;
using said workspace to transmit team proposed and facilitator approved potential problem solutions to said client workspace;
wherein if said client accepts said potential problem solution, and wishes to obtain IP rights prior to the release of said solution payment amount, transmitting unsigned IP release forms to said team, and upon receipt of signed IP release forms, then transmitting said solution payment amount to said team;
wherein at least prior to transmission of any said unsigned IP release forms, the identity of said client is not disclosed to said team.

13. The method of claim 12, wherein at least prior to transmission of said unsigned IP release forms, the identity of the team facilitator(s) and team problem solvers is also not disclosed to said client.

14. The method of claim 12, wherein after providing the confidential part of said problem statement, further performing the steps of:
obtaining facilitator moderated problem questions from said team, and using said team workspace to transmit said facilitator moderated questions to said client workspace;
obtaining client answers from said client, moderating said client questions at a system administrator level or at a facilitator level, and using said client workspace to transmit said client answers to said team workspace.

15. The method of claim 12, further obtaining mutual evaluations of all team members, and for each problem solver or facilitator, and further storing said mutual evaluations in said crowdsource computer database.

16. The method of claim 12, further using a web server to provide said team workspace and said client workspace as one or more web pages or app screens over the Internet, and wherein said team members and said clients interact with said team workspace and said client workspace using web browsers or application software running on team member or client computerized devices connected to the Internet; and
further using a web server to provide each individual problem solver and facilitator with their own home page as one or more web pages or app screens over the Internet using web browsers or application software running on each problem solver's or facilitator's computerized device connected to the Internet;
said home page comprising a list of problems that each individual problem solver or facilitator has been invited to solve, and problems that they are currently working on.

17. A computerized method of managing a confidential, moderated, crowdsourced problem solving process, said method comprising:
storing a plurality of problem solvers, facilitators and a list of their skills, personal background, and problem solving experience in a crowdsource computer database;
storing a plurality of problem statements, each problem statement having a non-confidential part and a confidential part and a solution payment amount, each problem statement further having an explicit or default list of relevant problem skills, and list of problem solver and facilitator inclusions or exclusions, and an associated client in a problem computer database;
solving at least one problem by:
using said problem to search said problem computer database for said list of explicit or default list of problem skills, and list of problem solver and facilitator inclusions or exclusions;
using said list of relevant problem skills, and list of problem solver facilitator inclusions or exclusions as an index to said crowdsource computer database to select matching problem solvers or matching facilitators that match said lists;
displaying said list of matching problem solvers and facilitators in a dashboard GUI, along with at least some information or links to information pertaining to their skills, personal background and problem solving experience;
wherein said dashboard GUI further displays the status of a plurality of problems originating from at least one client, along with a list of one or more teams associated with each problem, and team status information;
using said dashboard GUI to select at least one candidate facilitator to moderate said problem solving process, and a plurality of candidate problem solvers to participate in said problem solving process, and transmit a solving invitation comprising the non-confidential part of said problem statement and unsigned NDA agreements to said at least one candidate facilitator and plurality candidate problem solvers;
upon receipt of signed NDA agreements from said at least one candidate facilitator and plurality of candidate problem solvers, further using said dashboard GUI to select at least one candidate facilitator and plurality of candidate problem solvers to constitute a problem solving team comprising at least one chosen facilitator and a plurality of chosen problem solvers, and transmitting a team formation message to said team;
providing a confidential electronic team workspace for said problem;
providing an electronic client workspace for said problem;
providing the confidential part of said problem statement;
obtaining a facilitator moderated problem restatement from said team, and using said team workspace to transmit said problem restatement to said client workspace; and
using said client workspace to transmit client approval, modification, or rejection of said restatement to said team workspace;
wherein after providing said problem restatement to said client, further scheduling at least one voice communications session between said team and said client;
obtaining facilitator moderated problem questions from said team, and using said team workspace to transmit said facilitator moderated questions to said client workspace;
obtaining client answers from said client, and using said client workspace to transmit said client answers to said team workspace;
using said workspace to transmit team proposed and facilitator approved potential problem solutions to said client workspace;
wherein if said client accepts said potential problem solution, and wishes to obtain IP rights prior to release of said solution payment amount, transmitting unsigned IP release forms to said team, and upon receipt of signed IP release forms, then transmitting said solution payment amount to said team;
wherein at least prior to transmission of said unsigned IP release forms, the identity of said client is not disclosed to said team, and the identity of said team is not disclosed to said client; and
further obtaining mutual evaluations of all team members, and for each problem solver or facilitator, and further storing said mutual evaluations in said crowdsource computer database.

18. The method of claim 17, further using a web server to provide said team workspace and said client workspace as one or more web pages or app screens over the Internet, and wherein said team members and said clients interact with said team workspace and said client workspace using web browsers or application software running on team member or client computerized devices connected to the Internet; and
further using a web server to provide each individual problem solver and facilitator with their own home page as one or more web pages or app screens over the Internet using web browsers or application software running on each problem solver's or facilitator's computerized device connected to the Internet;
said home page comprising a list of problems that each individual problem solver or facilitator has been invited to solve, and problems that they are currently working on.

19. The method of claim 17, further moderating said client questions at a system administrator level or at a facilitator level before using said client workspace to transmit said client answers to said team workspace.
